(19) United States
(12) Patent Application Publication
(10) Pub. No.: US 2021/0137216 A1
(43) Pub. Date: May 13, 2021

(54) SHOE SOLE OR INSERT OF A UNITARY MATERIAL HAVING A GRADUAL CHANGE IN HARDNESSES AND/OR DENSITY CHARACTERISTICS AND A METHOD OF MAKING THE SAME

(71) Applicant: Arthur Robert Taylor, Tualatin, OR (US)

(72) Inventor: Arthur Robert Taylor, Tualatin, OR (US)

(21) Appl. No.: 16/949,659

(22) Filed: Nov. 9, 2020

Related U.S. Application Data
(60) Provisional application No. 62/931,910, filed on Nov. 7, 2019.

(51) Int. Cl. A43B 17/14; A43B 17/00; B29D 35/00

(52) U.S. Cl. CPC A43B 17/14; B29K 2105/04; B29D 35/0054; A43B 17/003

(57) ABSTRACT

A shoe sole or insert of a unitary material having a gradual change in hardness and/or density characteristics and a method manufacturing the same.

### CROSS-REFERENCE TO RELATED APPLICATION

This application claims the benefit of priority of U.S. provisional application No. 62/931,910, filed 7 Nov. 2019, the contents of which are herein incorporated by reference.

### BACKGROUND OF THE INVENTION

The present invention relates to shoe sole or inserts and, more particularly, a shoe sole or insert of a unitary material having a gradual change in hardness and/or density characteristics and a method manufacturing the same.

Shoe soles or inserts designed to assist in motion control or gait efficiency only do so by way of either (a) a single material of uniform density and hardness configured in various shapes or (b) by amalgamating a plurality of materials of different densities, hardness characteristics, and/or compression ratios. Thus, there is no shoe sole or insert embodied in a single material that provides a true gradual change in density and Shore durometer throughout its shape. Thus, there is no true solution for a gradual density and harness change in a singular material, which is problematic because a single material is easier to form or shape into the final shoe sole or insert, and a single material does not have discontinuities inherent in shoe sole or insert made from amalgamated materials.

As a result, current shoe inserts adapted to assist in a wearer's motion control or gait efficiency have the disadvantages of providing such assistance with local discontinuities between various materials of different durometers and densities under the foot.

Put another way current shoe soles or inserts only provide two or more densities and/or hardness characteristics by way of two or more materials, preventing gradual change in a continuous singular material, thereby current shoe soles or inserts do not provide a true gradual, continuous change in a finished sole, which can be beneficial.

Forming a unitary construction, like a shoe sole or insert, through amalgamating a plurality of materials (each material having a different density, compression characteristic, and/or hardness durometer) results into joints, regions of relative movement, and discontinuities between each material—preventing a true gradient of change under the foot for motion control in various directions.

As can be seen, there is a need for a shoe sole or insert of a unitary material having a gradual change in hardness and/or density characteristics and a method manufacturing the same. The process embodied in the present invention offers a shoe sole or insert with smooth and continuous change in durometer and density throughout its body and thus can be tailored as a function of performance application, solving the need for efficient and gradual changes to match the needs of a specific application of motion control and gait efficiency.

The present invention provides a true gradual transition in footwear for motion control and gait efficiency, with a single compound and part, without specific regional borders, discontinuities, and changes in durometers and materials—thereby providing a true gradual transition for a more efficient gate, with various applications from pronation control, supination control, unilateral control, heel to toe transition or toe to heel transition, and the like.

### SUMMARY OF THE INVENTION

In one aspect of the present invention, a shoe insert including a unitary continuous material comprising a heel portion and a forefoot portion, wherein each portion has a hardness at least two percent greater or less than the hardness of an adjacent portion; a medial longitudinal arch portion 54, a lateral longitudinal arch portion 52, and a transverse arch portion 56, wherein each arch portion has a hardness at least two percent greater or less than the hardness of the other arch portions, wherein the heel portion comprises a medial heel portion, a central heel portion 46, and a lateral heel portion 42, wherein each heel portion 44 has a hardness at least two percent greater or less than the hardness of the other heel portions, wherein the unitary continuous material is foam.

In another aspect of the present invention, the shoe insert includes a unitary continuous material comprising a medial portion 34, a lateral portion 32, and a central portion 36, wherein each portion has a hardness at least two percent greater or less than the hardness of an adjacent portion.

In yet another aspect of the present invention, the shoe insert includes a unitary continuous material comprising at least five zones, each zone defined by a longitudinal axis and a latitudinal axis, wherein each zone has a hardness at least two percent greater or less than the hardness of an adjacent zone, wherein each zone has a plurality of hardness characteristics, wherein each hardness characteristic of the plurality of hardness characteristics is a function of the longitudinal axis and the latitudinal axis.

In yet another aspect of the present invention, a method of manufacturing the above shoe insert includes shaping the unitary continuous material in a preform geometry comprising a preform heel portion and a preform forefoot portion (or preform medial portion, a preform lateral portion, and a preform central portion; or at least five zones), each having a thickness based in part on the hardness of the respective shoe insert portions; and compressing the preform geometry to form said shoe insert, wherein the compression of each preform portion/zone is a function of said hardness of the respective shoe insert portions/zones, and wherein the compression of each preform portion/zone is a function of a ratio of a thickness of each portion/zone of said shoe insert relative to said thickness of the respective preform portion/zone.

These and other features, aspects and advantages of the present invention will become better understood with reference to the following drawings, descriptions, examples and claims.

### BRIEF DESCRIPTION OF THE DRAWINGS

FIG. 1A is a lengthwise center cross-sectional view of an exemplary embodiment of a preform of the present invention, wherein the heel portion is disproportionately thicker than a forefoot portion in preparation for a heel to toe density change secondary molding process;

FIG. 1B is a rear elevation view of an exemplary embodiment of the preform of the present invention, wherein the heel portion is disproportionately thicker than the forefoot portion;

FIG. 1C is a medial and lateral elevation view of an exemplary embodiment of a finished shoe sole or insert having changing hardness along its longitudinal axis, as a result of the heel to toe density change secondary molding process applied to the initial preform (Note: all drawings showing hardness are reflected as “Durometer Shore C”.);

FIG. 1D is a top plan view of an exemplary embodiment of the shoe insert of the present invention resulting from the heel to toe density change process, illustrating the varying hardness characteristics resulting from the heel to toe density change secondary molding process;

FIG. 1E is a rear elevation view of an exemplary embodiment of the shoe sole or insert of the present invention resulting from the heel to toe density change secondary molding process;

FIG. 1F is a lengthwise center cross-sectional view of an exemplary embodiment of the apparatus of the present invention resulting from the heel to toe density change secondary molding process, illustrating the varying hardness characteristics (Shore C) from forefoot portion to heel portion;

FIG. 1G is a lengthwise center cross-sectional view of an exemplary embodiment of the preform of the present invention, illustrating the compression ratios engineered into the preform (as part of the secondary molding) to achieve the heel to toe durometer differences that is incorporated into the finished part (shoe sole or insert);

FIG. 1H is a lengthwise center cross-sectional view of an exemplary embodiment of the shoe sole or insert of the present invention, illustrating the varying hardness achieved by the compression ratios resulting from the heel to toe density change secondary molding process applied to the preform;

FIG. 2A is a side elevation view of an exemplary embodiment of a preform of the present invention, illustrating the lateral and medial perimeter being disproportionally thicker than the center, in preparation for a center to perimeter density change secondary molding process to be applied to the initial preform;

FIG. 2B is a schematic section view of the preform prepared for the center to perimeter density change secondary molding process;

FIG. 2C is a rear elevation view of an exemplary embodiment of the present invention, illustrating the full-length perimeter being disproportionally thicker than the center as a preform in preparation for the center to perimeter density change secondary molding process (or as a finished part having a uniform hardness) or as the shoe sole or insert resulting from the secondary molding process;

FIG. 2D is a medial and lateral side elevation view of an exemplary embodiment of a finished shoe sole or insert, illustrating the center to perimeter hardness changes;

FIG. 2E is a top plan view of an exemplary embodiment of the finished shoe sole or insert of the present invention, illustrating the varying hardness (Shore C) characteristics resulting from the center to perimeter density change secondary molding process;

FIG. 2F is a schematic view of the compression ratios applied to or to be applied to an exemplary embodiment of the preform during the secondary molding process, taken along section line 2F-2F in FIG. 2E;

FIG. 2G is a schematic view of the compression ratios of an exemplary embodiment of the preform of the present invention to be or being applied during the secondary molding process, taken along section line 2G-2G in FIG. 2E;

FIG. 2H is a schematic view of the compression ratios applied to or to be applied to an exemplary embodiment of the preform of the present invention during the secondary molding process, taken along section line 2H-2H in FIG. 2E;

FIG. 2J is a table of the compression ratios to be applied to or applied to an exemplary embodiment of the preform during the secondary molding process to effectuate various hardnesses (Shore C) of a unitary-material shoe sole or insert of the present invention taken along lines 2F-2F, 2G-2G, and 2H-2H in FIG. 2E;

FIG. 2K is a rear elevation view of an exemplary embodiment of the finished shoe sole or insert of the present invention, illustrating the varying latitudinal hardness characteristics resulting from the center to perimeter density change secondary molding process;

FIG. 2L is a lengthwise center cross-sectional view of an exemplary embodiment of the shoe sole or insert of the present invention, illustrating the varying longitudinal hardness (Shore C) characteristic achieved by the compression ratios applied to the preform during the center to perimeter density change secondary molding process (note, FIG. 2L is a reduced scale as compared to FIG. 2K);

FIG. 3A is a schematic section view of an exemplary embodiment of a preform of the present invention in preparation for a zonal density change secondary molding process;

FIG. 3B is a center sectional view of an exemplary embodiment of the finished shoe sole or insert of various hardnesses (Shore C) of the present invention resulting from the zonal density change secondary molding process;

FIG. 3C is a lateral sectional view of an exemplary embodiment of the finished shoe sole or insert hardnesses (Shore C) of the present invention resulting from the zonal density change secondary molding process;

FIG. 3D is a medial sectional view of an exemplary embodiment of the finished shoe sole or insert hardnesses (Shore C) of the present invention resulting from the zonal density change process;

FIG. 3E is a center sectional view of an exemplary embodiment of the finished shoe insert of the present invention resulting from the zonal density change secondary molding process, illustrating the varying compression ratios urged onto the initial preform;

FIG. 3F is a lateral sectional view of an exemplary embodiment of the present invention illustrating the varying compression ratios applied to the initial preform during the zonal density change secondary molding process;

FIG. 3G is a medial sectional view of an exemplary embodiment of the present invention illustrating the varying compression ratios applied to the initial preform during the zonal density change secondary molding process;

FIG. 3H is a rear elevation view of the view of an exemplary embodiment of the preform of the present invention in preparation for the zonal density change secondary molding process;

FIG. 3J is a top plan view of an exemplary embodiment of the finished shoe insert of the present invention resulting from the zonal density change secondary molding process, illustrating the varying longitudinal hardness (Shore C) characteristics;

FIG. 3K is a rear elevation view of an exemplary embodiment of the finished shoe sole or insert of the present invention resulting from the zonal density change secondary molding process, illustrating the latitudinal varying hardness (Shore C) characteristics; and

FIG. 4 shows various view of the process of manufacturing the shoe sole or insert.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Referring now to FIGS. 1A through 4, the present invention may include a finalized part (shoe sole or insert) of a unitary material having different hardness characteristics along different portions of its geometry, and a method of making the same. The unitary material may include but not be limited to EVA foam; Pebax foam, Hytrel foam, TPEE foam. PA foam, etc. The unitary material is urged through an initial molding or shaping process to form a preform 10 of the unitary material, shaped into one of a plurality of preform geometries.

Each preform geometry is specified for and a function of a desired resulting finalized part 20 (shoe sole or insert). Specifically, the shoe sole or insert 20 may be configured for one of a plurality of motion control and/or gait improvement applications, including but not limited to pronation control, supination control, unilateral control, heel to toe transition, toe to heel transition, or the like.

The shaping and geometry of the preform 10 is essential and must be precise, in order for the finished, tailored shoe sole insert 20 to achieve the desired gradual changes in density and hardness (durometer) characteristics, as will be explained further below. Simply put, a heel portion of the preform geometry may need to be over twice as thick as a forefoot portion so that the resulting finalized part has a higher hardness in the heel portion than the forefoot portion, even though the geometry of the finalized part 20 may have a heel portion with a thickness less than twice that of the forefoot portion (as a result of a difference in the compression between the heel portion and the forefoot portion). The finalized part (shoe sole or insert) 20 may be a finished sole, including a midsole unit, a fully foamed sole unit, or a partial sole component for a variety of footwear. Which, in part, explains why the hardness characteristic of the finalized part may vary heel-to-toe, center-to-perimeter, and/or across intermediate zones.

The preform 10 may result from a singular, raw (uncured), unitary material adapted in shape for a specific footwear and/or applications. The preform 10 may be the initially foamed part, an uncured mass urged into a mold and foamed into geometries (for preforms or for finished shoe sole or insert 20 of uniform density and hardness characteristics, and so does not require the secondary molding process). Alternatively, the preform 10 may result from a die cut foam part which that is shaped mechanically; in certain embodiments, foamed sheets that are mechanically shaped into the preform 10. In other words, the preform 10 can be formed through various methods, including direct foaming of uncured raw material, or by molding uncured material into specific shapes prior to foaming. Foaming occurs during this initial molding process, which expands raw, uncross linked material in a solid state (not expanded—there are various methods to expand the raw material into a foam during this initial molding process). Types of initial expansion molding can be done by way of activating blowing agents included in the unitary material, but also through heat and pressure molding, or via “autoclave” molding (heating in pressurized chambers). Another method could be ‘physical foaming’, utilizing gasses such as nitrogen, CO2, etc.

A method of making the present invention may include the following. The initial foamed preform 10 of a uniform material and harness disclosed above may be provided through molding the unitary material into the desired preform geometry or through being manually shaped from a large block of foam and then buffed and grinded down by machines to the desired preform geometry.

The preform geometry is a function of the compression ratios urged during secondary molding process resulting in the finalized part geometry having different hardness characteristic along different portions thereof. Thereby the shoe sole or insert 20 may have a heel-to-toe, a center-to-perimeter, and/or a zonal density change profile, as illustrated in the FIGS. (though it should be understood that there can be other density change profiles of the present invention, not shown in the FIGS.), to create the finished, tailored shoe sole or insert 20 which has the desired durometers in the various areas created through the pressure and temperature applied to the preform 10 during the secondary molding process.

In one variation, the initial molding process is done via heat and pressure to activate the raw material to expand into a foamed part yielding the desired geometries needed to achieve the compression ratios needed in the finalized part 20 (urged during the secondary molding process) so that the finalized part 20 has a changing durometer as it extends longitudinally and/or latitudinally.

Regarding compression ratios, the compression ratio is the ratio of the finalized part portion relative to the initial preform portion—e.g., a compression ratio of 65% means that that portion of the finalized part 20 is 65% of that portion of the preform 10. Put differently, the more a portion of the preform 10 is compressed, the harder that portion of the finalized part 20. For instance, since the unitary material of the preform 10 has a uniform hardness, the smaller the compression ratio the greater the compression urged on that portion of the preform 10 and, as a corollary, the greater the hardness at that portion.

In other words, the process of the present invention may include creating an initial preform 10 of same durometer forming the required geometry of the final shoe sole or insert 20, and then subject to the secondary molding process to achieve the desired varying durometer portions through the singular material that is the finalized part/shoe sole or insert 20. The preform geometry is subject to the secondary molding process, including pressing, heating and cooling, where different compression ratios are urged along different portions of the preform 10 to resulting a finalized geometry reflecting the different compression ratios applied to the preform 10. The secondary molding process can result in the heel to toe finalized part 20, wherein the finished part 20 is significantly harder in the heel versus the front of the sole. It being understood that in order to achieve this in the secondary molding process; for instance, the preform 10 needs to be thicker in the heel (see FIG. 1G) so that a relatively (compared to the forefoot portion) higher “compression ratio” can be urged in the heel portion to achieve a compression ratio of 64%, making the heel portion have a hardness characteristic of 70c (see FIG. 1C) on finished part, while the forefoot portion foam is aimed at a compression ratio of 44% (FIG. 1G), thereby yielding a hardness of only 55c (FIG. 1C).

The ability to create preform 10 parts of different geometry from which finished shoe insert 20 parts of different properties can be formed allows for varying durometers as well as various physical property characteristics beneficial to the motion control and gait-improvement applications discussed above.

A method of using the present invention includes the following. By inserting the finished, tailored shoe sole or insert 20 into footwear, the present invention enables the user to have a natural and gradual transition in foot-strike, for various applications such as supination, pronation, bi-lateral motion control that incorporates transition from different foam hardnesses and/or properties along different (center, medial, lateral, longitudinal, and latitudinal) portions of the shoe sole or insert 20. Thereby, the finished shoe sole or insert 20 can be tailored to a specific foot-strike need, depending on the application or activity.

Additionally, a catching glove which might have firmer foam in the center area and softer characteristic toward the fingers, may use the process embodied in the present invention, allowing for more agility at the finger tips, while more cushioning in the center (where impacts are designed to occur). Likewise, the present invention can be incorporated in footwear soles, sports equipment, as well as cushioning foam applications for other industries.

It should be understood, of course, that the foregoing relates to exemplary embodiments of the invention and that modifications may be made without departing from the spirit and scope of the invention as set forth in the following claims.

What is claimed is:

1. A shoe insert comprising:
a unitary continuous material comprising a heel portion and a forefoot portion, wherein each portion has a hardness at least two percent greater or less than the hardness of an adjacent portion.

2. The shoe insert of claim 1, further comprising a medial longitudinal arch portion, a lateral longitudinal arch portion, and a transverse arch portion, wherein each arch portion has a hardness at least two percent greater or less than the hardness of the other arch portions.

3. The shoe insert of claim 1, wherein the heel portion comprises a medial heel portion, a central heel portion, and a lateral heel portion, wherein each heel portion has a hardness at least two percent greater or less than the hardness of the other heel portions.

4. The shoe insert of claim 1, wherein the unitary continuous material is foam.

5. A shoe insert comprising:
a unitary continuous material comprising a medial portion, a lateral portion, and a central portion, wherein each portion has a hardness at least two percent greater or less than the hardness of an adjacent portion.

6. A shoe insert of claim 5, wherein the unitary continuous material is foam.

7. A shoe insert comprising:
a unitary continuous material comprising at least five zones, each zone defined by a longitudinal axis and a latitudinal axis, wherein each zone has a hardness at least two percent greater or less than the hardness of an adjacent zone.

8. The shoe insert of claim 7, wherein each zone has a plurality of hardness characteristics, wherein each hardness characteristic of the plurality of hardness characteristics is a function of the longitudinal axis and the latitudinal axis.

9. A shoe insert of claim 8, wherein the unitary continuous material is foam.

10. A method of manufacturing the shoe insert of claim 1, the method comprising:
shaping the unitary continuous material in a preform geometry comprising a preform heel portion and a preform forefoot portion, each having a thickness based in part on the hardness of the respective shoe insert portions; and
compressing the preform geometry to form said shoe insert.

11. The method of claim 10, wherein the compression of each preform portion is a function of said hardness of the respective shoe insert portions.

12. The method of claim 10, wherein the compression of each preform portion is a function of a ratio of a thickness of each portion of said shoe insert relative to said thickness of the respective preform portion.

13. A method of manufacturing the shoe insert of claim 5, the method comprising:
shaping the unitary continuous material in a preform geometry comprising a preform medial portion, a preform lateral portion, and a preform central portion, each having a thickness based in part on the hardness of the respective shoe insert portions; and
compressing the preform geometry to form said shoe insert.

14. The method of claim 13, wherein the compression of each preform portion is a function of said hardness of the respective shoe insert portions.

15. The method of claim 13, wherein the compression of each preform portion is a function of a ratio of a thickness of each portion of said shoe insert relative to said thickness of the respective preform portion.

16. A method of manufacturing the shoe insert of claim 7, the method comprising:
shaping the unitary continuous material in a preform geometry comprising at least five preform zones, each preform zone having a thickness based in part on the hardness of the respective shoe insert portions; and
compressing the preform geometry to form said shoe insert.

17. The method of claim 13, wherein the compression at each zone is a function of said hardness of the respective shoe insert zones.

18. The method of claim 13, wherein the compression at each zone is a function of a ratio of a thickness of each zone of said shoe insert relative to said thickness of the respective preform zone.
